(19) United States
(12) Patent Application Publication
(10) Pub. No.: US 2025/0368014 A1
(43) Pub. Date: Dec. 4, 2025

(54) DYNAMIC OPACITY VARIATION FOR VEHICLE ROOF GLASS SYSTEM

(71) Applicant: Rivian IP Holdings, LLC, Irvine, CA (US)

(72) Inventors: Daniel Loren HEPLER, Nanaimo (CA); Glenn FEINBERG, Carlsbad, CA (US)

(21) Appl. No.: 19/023,036

(22) Filed: Jan. 15, 2025

Related U.S. Application Data
(60) Provisional application No. 63/652,592, filed on May 28, 2024.

(51) Int. Cl. B60J 3/04; B62D 25/06

(52) U.S. Cl. CPC B60J 3/04; B62D 25/06

(57) ABSTRACT

Aspects of the subject disclosure relate to dynamic opacity variation for a glass system. A device implementing the subject technology may include a glass system and a controller configured to cause modulation of an input voltage supply to generate a pair of differential bias voltage signals. The controller may also cause one or more adjustments to an opacity of the glass system using the pair of differential bias voltage signals. In some aspects, the one or more adjustments correspond to different levels of opacity between an opaque state and a transparent state of the glass system.

### CROSS-REFERENCE TO RELATED APPLICATION(S)

This application claims the benefit of U.S. Provisional Application Ser. No. 63/652,592, entitled “DYNAMIC OPACITY VARIATION FOR VEHICLE ROOF GLASS SYSTEM,” and filed on May 28, 2024, the disclosure of which is expressly incorporated by reference herein in its entirety.

### INTRODUCTION

Polymer Dispersed Liquid Crystal (PDLC) roof glass technology has applications in electric vehicles, offering adjustable light transmission and enhanced thermal management. This technology consists of liquid crystal droplets dispersed in a polymer matrix, sandwiched between two glass layers with conductive coatings. When an electric field is applied, the liquid crystals align, changing the transparency of the glass. PDLC roof glass can provide improved energy efficiency by reducing the need for air conditioning, thereby extending the range of electric vehicles. Additionally, this technology can enhance passenger comfort by controlling the amount of sunlight entering the vehicle.

### SUMMARY

The subject technology provides for migrating certain hardware functions for existing vehicle roof glass systems or smart films into a software environment.

In accordance with one or more aspects of the disclosure, a system is provided that includes a roof glass system and a controller configured to cause modulation of an input voltage supply to generate a pair of differential bias voltage signals and cause one or more adjustments to an opacity of the roof glass system using the pair of differential bias voltage signals. In some aspects, the one or more adjustments correspond to different levels of opacity between an opaque state and a transparent state of the glass system.

In accordance with one or more aspects of the disclosure, a method includes generating a plurality of differential bias voltage signals by modulating an input voltage supply with a plurality of input pulse width modulation signals. The method also includes biasing a roof glass system of a vehicle with the plurality of differential bias voltage signals to adjust an opacity of the roof glass system. In some aspects, the adjustment to the opacity corresponds to different levels of opacity between an opaque state and a transparent state of the glass system.

In accordance with one or more aspects of the disclosure, a vehicle including a battery; a roof glass system; a power converter configured to receive an input voltage supply from the battery and convert the input voltage supply from a first voltage to a second voltage greater than the first voltage; an inverter coupled to the power converter and configured to generate a pair of differential bias voltage signals by modulating the input voltage supply at the second voltage with a plurality of input pulse width modulation signals; and a controller configured to cause one or more adjustments to an opacity of the roof glass system with the pair of differential bias voltage signals. In some aspects, the one or more adjustments correspond to different levels of opacity between an opaque state and a transparent state of the glass system.

### BRIEF DESCRIPTION OF THE DRAWINGS

Certain features of the subject technology are set forth in the appended claims. However, for purpose of explanation, several embodiments of the subject technology are set forth in the following figures.

FIG. 1A illustrates a schematic perspective side view of an example implementation of a vehicle having a roof glass system in a transparent state in accordance with one or more implementations.

FIG. 1B illustrates a schematic perspective side view of an example implementation of a vehicle having a roof glass system in an opaque state in accordance with one or more implementations.

FIG. 2A illustrates a schematic perspective side view of another example implementation of a vehicle having a roof glass system in a transparent state, in accordance with aspects of the present disclosure.

FIG. 2B illustrates a schematic perspective side view of another example implementation of a vehicle having a roof glass system in an opaque state, in accordance with aspects of the present disclosure.

FIG. 3A illustrates a cross-sectional view of a roof glass system in a transparent state in accordance with one or more implementations.

FIG. 3B illustrates a cross-sectional view of a roof glass system in an opaque state in accordance with one or more implementations.

FIG. 4 illustrates a flow diagram of an example process for performing dynamic opacity variation in a roof glass system in accordance with one or more implementations of the subject technology.

FIG. 5 illustrates a block diagram of an example power system for performing dynamic opacity variation in a roof glass system in accordance with one or more implementations of the subject technology.

FIG. 6 illustrates a plot diagram of example differential waveforms for performing dynamic opacity variation in a roof glass system in accordance with one or more implementations of the subject technology.

FIG. 7A illustrates a block diagram of an example computer system in accordance with one or more implementations of the subject technology.

FIG. 7B illustrates a block diagram of example firmware for the computer system of FIG. 7A in accordance with one or more implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form to avoid obscuring the concepts of the subject technology.

In one or more implementations, the vehicle roof glass system enables users to adjust the roof glass tint from transparent to opaque using various methods, such as a touchscreen display or a mobile application. For example, polymer-dispersed liquid crystal (PDLC) systems for vehicle roof glass applications involve a composite material consisting of liquid crystal droplets dispersed within a polymer matrix. These systems leverage the light-modulating properties of liquid crystals, which can change their alignment in response to an electric field, thereby altering the transparency of the PDLC glass in the vehicle roof glass system. When no voltage is applied, the liquid crystals scatter light, causing the PDLC glass to appear opaque. When an electric field is applied, the liquid crystals align, allowing light to pass through and the PDLC glass to become transparent. However, the hardware used in existing vehicle roof glass applications may operate only in ON/OFF states, with no ability to vary the tint based on user preferences. This limitation means that any setting between 0% and 100% pulse width modulation (PWM) results in an inconsistent opacity that is not desirable.

The subject technology provides for dynamic opacity variation for roof glass systems. A system includes a roof glass system and a controller configured to cause modulation of an input voltage supply to generate a pair of differential bias voltage signals and cause one or more adjustments to an opacity of the roof glass system using the pair of differential bias voltage signals. In one or more implementations, the controller is further configured to cause one or more adjustments to a duty cycle of at least one input pulse width modulation signal to modulate the input voltage supply. In one or more other implementations, the controller is further configured to cause a conversion of the input voltage supply from a first voltage to a second voltage greater than the first voltage, wherein the input voltage supply at the second voltage is modulated with a pair of input pulse width modulation signals. In one or more other implementations, the controller is further configured to cause driving a transition from an opaque state to a transparent state of the roof glass system based on the pair of differential bias voltage signals having a nonzero differential output voltage. In one or more other implementations, the controller is further configured to cause driving a transition from a transparent state to an opaque state of the roof glass system based on the pair of differential bias voltage signals having a zero differential output voltage. In some aspects, the one or more adjustments to the opacity of the roof glass system corresponds to a fading effect based on a number of voltage steps in each of the pair of differential bias voltage signals.

Migrating certain hardware functions for existing vehicle roof glass systems or smart films into a software environment offers several advantages. First, it enhances flexibility and scalability, allowing for easier updates and improvements without the need to modify physical components. Software-based control can provide more precise and customizable adjustments to the vehicle roof glass system's transparency levels, enabling finer control over light and heat transmission. Second, integrating hardware functions into software can reduce overall system costs by minimizing the number of physical components required including reducing the interconnection bus footprint. This can lead to lower production costs and simpler installation processes, as fewer hardware elements need to be managed and connected. Third, software-driven systems can improve reliability and maintenance. Software can be more easily monitored and diagnosed for issues, allowing for quicker and more efficient troubleshooting. Additionally, software updates can be deployed remotely, allowing the system to remain up-to-date with the latest features and security patches without needing physical intervention. Lastly, software control can enhance user experience by providing more intuitive and user-friendly interfaces for controlling vehicle roof glass systems. Features such as programmable settings, automated adjustments based on environmental conditions, and remote control via mobile devices can significantly improve the convenience and functionality of vehicle roof glass systems.

Benefits of vehicle roof glass systems include providing privacy when needed by switching from transparent to opaque and reducing glare to improve comfort and visibility for occupants experiencing excessive sunlight through the roof. The vehicle roof glass, paired with a metallic coating, blocks most infrared light from entering the cabin, keeping the interior of a vehicle cooler on hot, sunny days, regardless of whether the glass opacity is in the ON or OFF state. The combination of the vehicle roof glass and the metallic coating allows for lower tint levels, enhancing visible light transmission and enabling occupants to see more, although there is some haze in the glass when in the opaque state. This system provides an alternative method to block visible light without requiring an additional roller sunshade, preserving headroom and aligning with the interior design of the vehicle. Additionally, eliminating the need for a sunshade reduces the potential for additional part failures and makes the glass easier to clean compared to sunshade fabric. The laminated glass, which may include additional polymer layers such as a polyethylene terephthalate (PET) film and a polyvinyl butyral (PVB) layer, can improve noise levels in the cabin compared to existing roof glass applications.

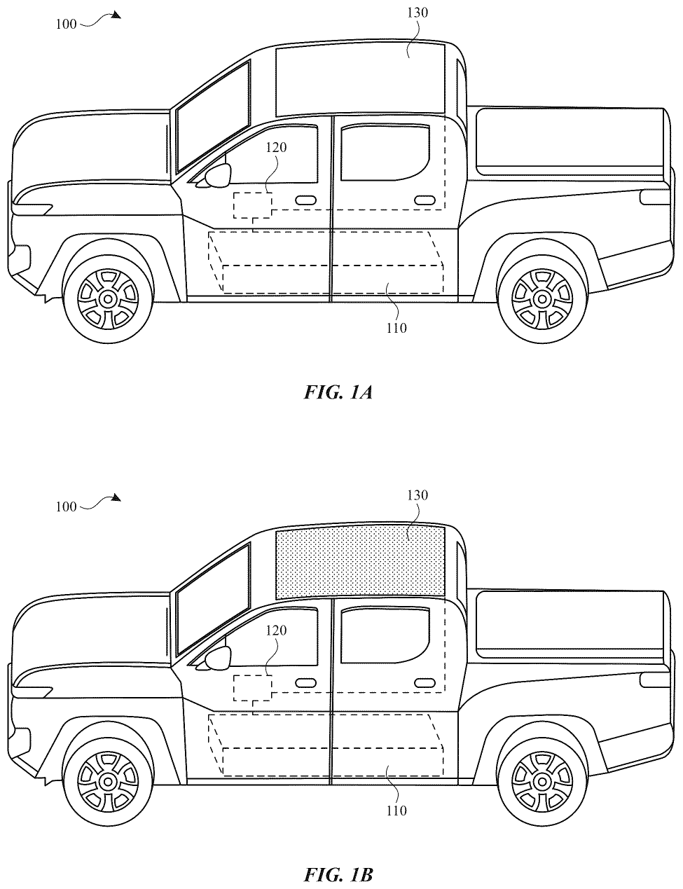

FIGS. 1A and 1B illustrate a schematic perspective side view of an example implementation of a vehicle 100 in accordance with one or more implementations. As shown in FIGS. 1A and 1B, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive wheels of the vehicle 100 using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid). In various implementations, the vehicle 100 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIGS. 1A and 1B, the vehicle 100 is implemented as a truck (e.g., a pickup truck) having a battery pack 110. As shown, the battery pack 110 may include one or more battery modules (not shown), which may include one or more battery cells (not shown). A vehicle battery pack can include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle 100 (e.g., including one or more power outlets of the vehicle 100 and/or the motor(s) that drive the wheels of the vehicle 100). The power stage circuit can be provided as part of the battery pack 110 or separately from the battery pack 110 within the vehicle 100.

In the example of FIG. 1A, the vehicle 100 includes a roof glass system 130 in a transparent state. In the example of FIG. 1B, the vehicle 100 includes a roof glass system 130 in an opaque state. In one or more implementations, the roof glass system 130 includes a PDLC system. In one or more implementations, PDLC systems for vehicle roof glass applications involve a composite material consisting of liquid crystal droplets dispersed within a polymer matrix. These systems leverage the light-modulating properties of liquid crystals, which can change their alignment in response to an electric field, thereby altering the transparency of the PDLC glass in the roof glass system 130. When no voltage is applied, the liquid crystals scatter light, causing the PDLC glass to appear opaque. When an electric field is applied, the liquid crystals align, allowing light to pass through and the PDLC glass to become transparent.

In some implementations, the battery pack 110 can be combined with a controller 120 that causes modulation of an input voltage supply (from the battery pack 110) to generate a pair of differential bias voltage signals and causes one or more adjustments to an opacity of the roof glass system 130 using the pair of differential bias voltage signals.

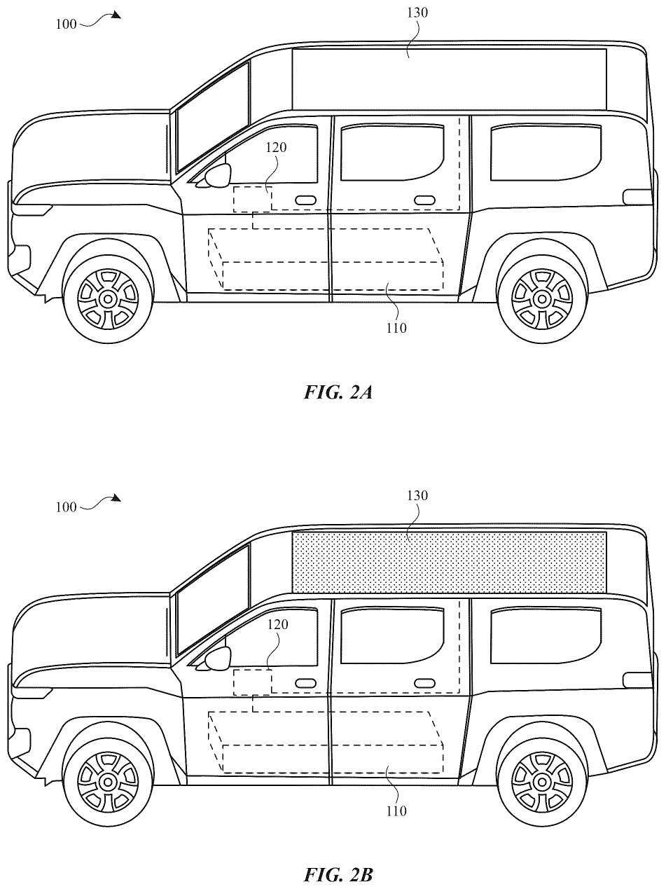

The example of FIG. 1 in which the vehicle 100 is implemented as a pickup truck having a truck bed at the rear portion thereof is merely illustrative. For example, FIGS. 2A and 2B illustrate another implementation in which the vehicle 100 including the battery pack 110 is implemented as a sport utility vehicle (SUV), such as an electric sport utility vehicle. In the example of FIGS. 2A and 2B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus). In the example of FIG. 2A, the vehicle 100 includes a roof glass system 130 in a transparent state. In the example of FIG. 2B, the vehicle 100 includes a roof glass system 130 in an opaque state.

One of the main distinctions from existing PDLC systems or smart films is the migration of certain hardware functions into a software environment. In one or more implementations, differential waveforms can be provided, allowing adjustments based on specific conditions of the vehicle 100, such as battery state or other influencing factors. These differential waveforms, applied to the PDLC glass in the roof glass system 130, can be tailored to optimize performance under varying conditions, enhancing the functionality and adaptability of the roof glass system 130.

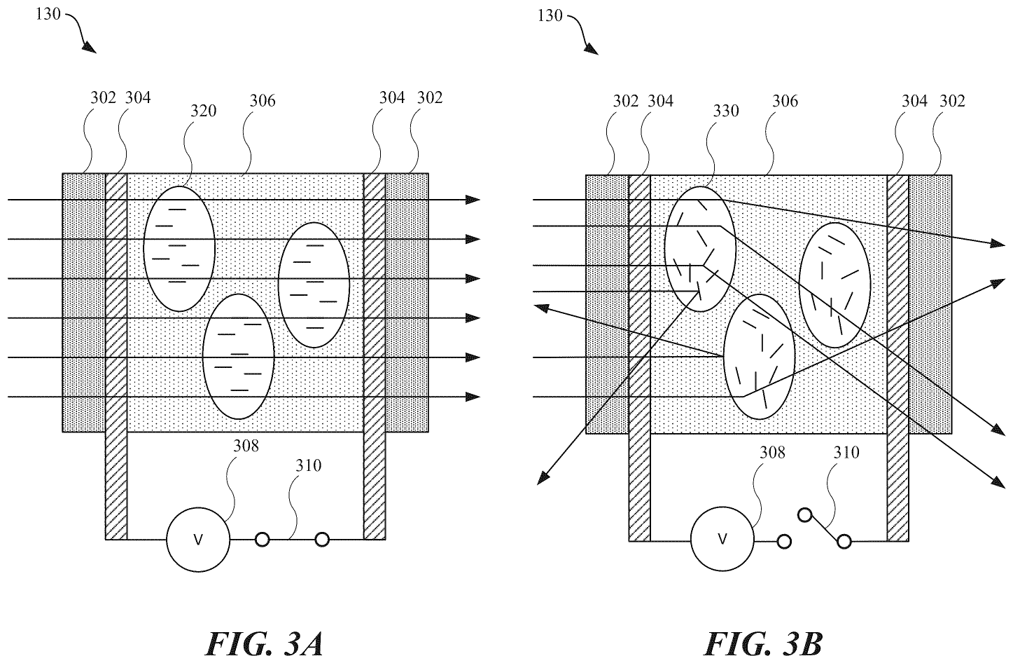

FIG. 3A illustrates a cross-sectional view of a roof glass system 130 in a transparent state in accordance with one or more implementations. FIG. 3B illustrates a cross-sectional view of a roof glass system 130 in an opaque state in accordance with one or more implementations. As illustrated in FIGS. 3A and 3B, the roof glass system 130 includes a PDLC system. In one or more implementations, the roof glass system 130 includes a PET layer 302, which serves as a substrate providing mechanical support and flexibility to the structure. In one or more implementations, the roof glass system 130 also includes a polymer matrix layer 306 embedded with groups of liquid crystals. The polymer matrix layer 306 hosts the liquid crystals, allowing them to be uniformly distributed and suspended within the polymer matrix layer 306. The liquid crystals within the polymer matrix layer 306 can change their orientation in response to an applied electric field, which alters the optical properties of the roof glass system 130, such as transparency and opacity.

The roof glass system 130 also includes a conductive coating layer 304, which is applied to the PET layer 302. The conductive coating layer 304 may allow for the application of an electric field across the liquid crystals by facilitating the flow of electric current. In one or more other implementations, a metallic coating (not shown) provides a reflective surface that can enhance the visibility of the liquid crystals' optical changes when the electric field is applied. In one or more implementations, the metallic coating is integrated within at least a portion of the PET layer 302.

In one or more implementations, the conductive coating layer 304 is electrically coupled to a voltage source 308 in series with a switch 310. This configuration allows the electric field to be controlled by opening or closing the switch 310. When the switch 310 is closed as illustrated in FIG. 3A, the electric field is applied, causing the liquid crystals to align in a specific orientation as illustrated by a group of liquid crystals 320, which changes the optical properties of the roof glass system 130. Conversely, when the switch 310 is open as illustrated in FIG. 3B, the electric field is removed, and the liquid crystals return to their random orientation as illustrated by a group of liquid crystals 330, reverting the roof glass system 130 to its initial optical state. This arrangement allows for controlled modulation of light transmission through the roof glass system 130.

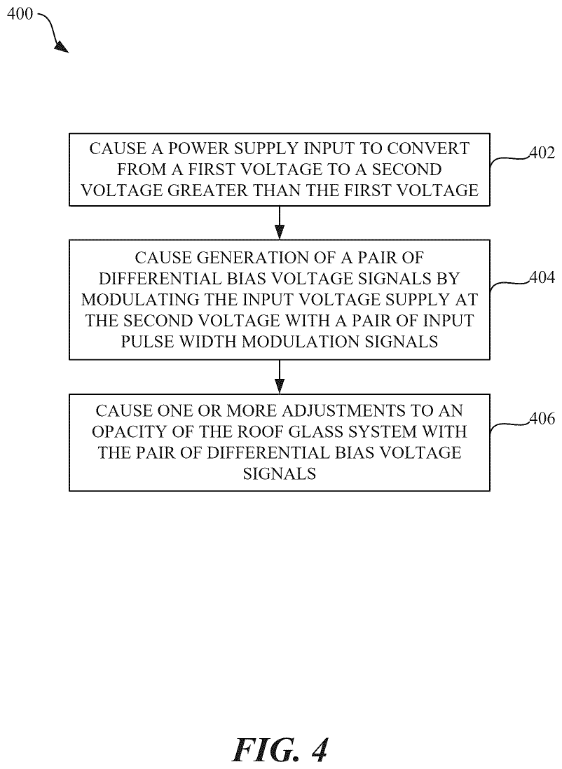

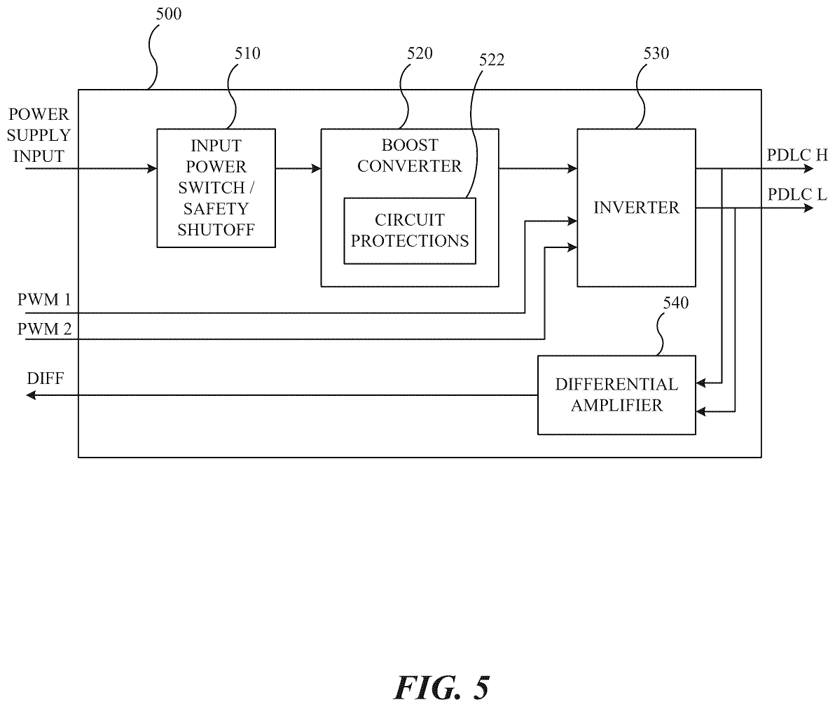

FIG. 4 illustrates a flow diagram of an example process 400 for performing dynamic opacity variation in a roof glass system in accordance with one or more implementations of the subject technology. For explanatory purposes, the process 400 is primarily described herein with reference to the vehicle 100 of FIGS. 1A-B and 2A-B, and/or various components thereof. However, the process 400 is not limited to the vehicle 100 of FIGS. 1A-B and 2A-B, and one or more steps (or operations) of the process 400 may be performed by one or more other structural components of the vehicle 100 and/or of other suitable moveable apparatuses, devices, or systems. Further, for explanatory purposes, some of the steps of the process 400 are described herein as occurring in serial, or linearly. However, multiple steps of the process 400 may occur in parallel. In addition, the steps of the process 400 need not be performed in the order shown and/or one or more steps of the process 400 need not be performed and/or can be replaced by other operations. For purposes of brevity in explanation, aspects of the process 400 will be discussed with reference to FIG. 5. FIG. 5 illustrates a block diagram of an example power control system 500 for performing dynamic opacity variation in a roof glass system in accordance with one or more implementations of the subject technology.

In one or more other implementations, the power control system 500 may include one or more voltage step-up mechanisms to an intermediate bus, followed by an inverter (e.g., inverter 530) to generate a differential waveform having an alternating current (AC) voltage to drive the PDLC glass of the roof glass system 130. In one or more implementations, the intermediate bus may be controlled via a pin to manage the amplitude of the differential PWM output.

The controller 120 may utilize a state machine to control the roof glass system 130 behavior. In one or more implementations, user inputs to the controller 120 are converted into specific requests to the power control system 500. The power control system 500 then activates the PDLC glass in the roof glass system 130 with complementary voltage biasing and initiates visual effects, such as fading, before entering a steady-state operation. When the user opts to turn off the roof glass system 130, the user input triggers a transition phase, during which the glass tint fades out, the circuitry in the power control system 500 powers down, and energy consumption is minimized.

During operation of the power control system 500, a startup sequence may be initiated that includes applying an input voltage (e.g., 12 V) to the input power switch module 510 and checking all conditions are normal, including checking for short circuits or open circuits and verifying that voltages and currents are within acceptable ranges. The boost converter 520 is then activated, and its output is monitored by the circuit protections module 522 to ensure it remains within range. Subsequently, the amplitude of the output is gradually increased by modulating the PWM duty cycle with the inverter 530, continuously monitoring the complementary outputs with the differential amplifier 540 to ensure all parameters stay within specified limits.

Throughout the process, the power control system 500 may continuously monitor various inputs for faults. Upon detecting a fault, the power control system 500 may take appropriate action to de-energize the circuit safely, providing reliable operation and protection of the hardware. This sequence ensures controlled activation, operation, and deactivation of the PDLC glass in the roof glass system 130, all managed via the controller 120.

In one or more implementations, the inverter 530 employs open-loop control. In one or more other implementations, the inverter 530 employs closed-loop control for more precise waveform management and to accommodate variations in manufacturing or load impedance. In one or more implementations, closed-loop control may involve measuring voltage and current and adjusting the waveform amplitude accordingly to maintain consistent performance across the roof glass system 130.

Referring back to FIG. 4, at step 402, the controller 120 may cause a power supply input to ramp up from a first voltage to a second voltage. The power control system 500 designed for the roof glass system 130 includes multiple components to facilitate efficient and safe operation. The power control system 500 begins with an input power switch module 510, which serves as a safety shutoff module, providing the ability to disconnect a power supply input in case of a fault or emergency. Connected to the input power switch module 510 is a boost converter 520, responsible for stepping up the voltage to the required level for the roof glass system 130. In one or more implementations, the boost converter 520 may be implemented as a DC-DC booster with comprehensive protections. The boost converter 520 may be equipped with a circuit protections module 522 to guard against overvoltage, overcurrent, and other electrical faults, facilitating reliable performance and protecting the components of the power control system 500 and/or the roof glass system 130. In one or more other implementations, the circuit protections module 522 includes a high-side driver switch (e.g., 12 V) that is utilized for safety overcurrent fault management, incorporating various protection mechanisms.

Referring back to FIG. 4, at step 404, the controller 120 may cause generation of a pair of differential bias voltage signals by modulating the input voltage supply at the second voltage with a pair of input pulse width modulation signals. The output from the boost converter 520 may be fed into an inverter 530. In one or more other implementations, the inverter 530 may be implemented as a full-bridge DC/AC inverter to generate the pair of differential bias voltage signals (depicted in FIG. 5 as two differential PDLC output signals: PDLC H and PDLC L). The inverter 530 may convert the DC voltage to an AC signal for driving the roof glass system 130. The inverter 530 can receive two input PWM signals (e.g., PWM 1 and PWM 2) and generate two differential PDLC output signals: a high signal (e.g., PDLC H) and a low signal (e.g., PDLC L). These two differential PDLC output signals can cause control of the transparency levels of the roof glass system 130 by adjusting the electrical field applied to the liquid crystals in the PDLC glass of the roof glass system 130, enhancing its ability to modulate light transmission effectively.

The inverter 530 may include a first gate driver, two or more power transistors and a first LC filter on the signal path to the PDLC high output. Similarly, the inverter 530 may include a second gate driver, two or more power transistors and a second LC filter on the signal path to the PDLC low output. One of the two input PWM signals (e.g., PWM 1) is fed to a high-side terminal of the first gate driver and to a low-side terminal of the second gate driver. Conversely, the second input PWM signal (e.g., PWM 2) is fed to a low-side terminal of the first gate driver and to a high-side terminal of the second gate driver. The duty cycles of the two PWM signals are complementary, providing that while one output maintains a certain duty cycle, the other exhibits the opposite duty cycle, resulting in complementary output voltages (e.g., PDLC H, PDLC L).

In one or more implementations, when both input PWM signals (e.g., PWM 1 and PWM 2) are set to 50% duty cycle, these signals are complementary of one another (e.g., PWM 1 is high while PWM 2 is low). Consequently, there may be a 50% high signal on the signal path to the PDLC high output and a 50% low signal on the signal path to the PDLC low output, resulting in no voltage difference across the circuit. This condition may correspond to the differential voltage being zero, indicating that the roof glass system 130 is in an off state (or opaque state).

The output of the inverter 530 is connected to a differential amplifier 540. The differential amplifier 540 can receive the high and low PDLC signals (e.g., PDLC H, PDLC L) from the inverter 530 and produce a differential output (e.g., DIFF), which provides a balanced signal that can effectively drive the roof glass system 130. The differential amplifier 540 can ensure that the signal integrity is maintained and minimizes any potential noise or interference that may affect the performance of the roof glass system 130.

In one or more implementations, most control over the differential waveform is moved to software from hardware. In one or more implementations, a front-end control feature emphasizes the software aspect, particularly using pulse width modulation techniques managed by the controller 120. In one or more implementations, the power control system 500 employs PWM in software to control the differential waveform to the PDLC glass of the roof glass system 130. By varying the PWM, the differential waveform can be adjusted to optimize bus voltage utilization, allowing for a lower bus voltage and potentially more efficient operation. The differential waveform can be modified to various shapes, such as sinusoidal, trapezoidal, or square wave, to enhance the optical properties of the PDLC glass in the roof glass system 130. In one or more other implementations, waveform adjustments can be made to optimize power consumption.

In one or more implementations, the switch 310 depicted in FIGS. 3A and 3B may be controlled by the controller 120, which may also control the high-side driver in the circuit protections module 522, the boost converter 520, and facilitate generation of the differential PDLC output (e.g., PDLCH, PDLC L). This software integration combines the functionality of the switch 310 with that of the voltage source 308 in FIG. 3.

Referring back to FIG. 4, at step 406, the controller 120 may cause one or more adjustments to an opacity of the roof glass system 130 with the pair of differential bias voltage signals. For example, the controller 120 may apply the pair of differential bias voltage signals with a nonzero differential output voltage to the roof glass system 130 to cause a transition between an opaque state and a transparent state.

In one or more implementations, the differential output voltage (e.g., PDLC H, PDLC L) causes the PDLC glass to undergo changes in transparency (or dynamic opacity variation) by orienting its liquid crystals into a certain alignment within the polymer matrix layer 306 when applied with an electric field. For example, the differential voltage may drive the excitation of the PDLC glass in the roof glass system 130, aligning the liquid crystals within the polymer matrix layer 306 to transition the PDLC glass from an opaque state to a transparent state. This process allows the PDLC glass to transition between opaque and transparent states based on the applied voltage.

In one or more implementations, to accelerate the fading process (or transition between opaque and transparent), adjustments can be made to the duty cycle of each PWM signal (e.g., sine wave shape), which directly affects the corresponding output voltage. This modulation of the duty cycle allows for control over the amount of current flowing through the power control system 500. The output voltage can be monitored, and variations in load impedance can lead to fluctuations in the output voltage. In one or more implementations, the power control system 500 can compensate by increasing the amplitude of the input PWM signal to drive the gate driver in the inverter 530 with a higher voltage, thus maintaining the desired output level.

In one or more implementations, when a nonzero differential output voltage (e.g., PDLC H, PDLC L) is present, this differential output voltage can drive the transition from the opaque state to the transparent state of the PDLC glass. In this regard, the level of transparency may increase with higher drive voltages. As discussed above, this transition from opaque to transparent is facilitated by the alignment of the liquid crystals in the polymer matrix layer 306 within the PDLC glass. In its off state, the liquid crystals are randomly oriented, causing light diffusion and resulting in an opaque appearance. However, when a nonzero AC voltage is applied, the applied electric field causes the liquid crystals to align in a certain orientation, allowing light to pass through the PDLC glass coherently, resulting in transparency.

In one or more implementations, the controller 120 can transition the PDLC glass between fully opaque and fully transparent states, resulting in a fading effect. This transition can occur gradually over time, creating a smoother and more granular change in opacity. The fading effect can represent a softer transition that is perceptible to a user of the vehicle 100, as opposed to an abrupt and instantaneous change in opacity.

In one or more implementations, the controller 120 can cause intermediate state transitions between full opacity and full transparency. For example, a partial level of opacity may be configured, falling between the fully opaque and fully transparent states. This intermediate state may include a gradual transition for a smoother effect. For example, instead of transitioning from zero volts to 48 volts as in a full fade scenario, the transition may be limited to a narrower range, such as from zero volts to 12 volts or zero volts to 15.5 volts, to achieve the desired level of opacity.

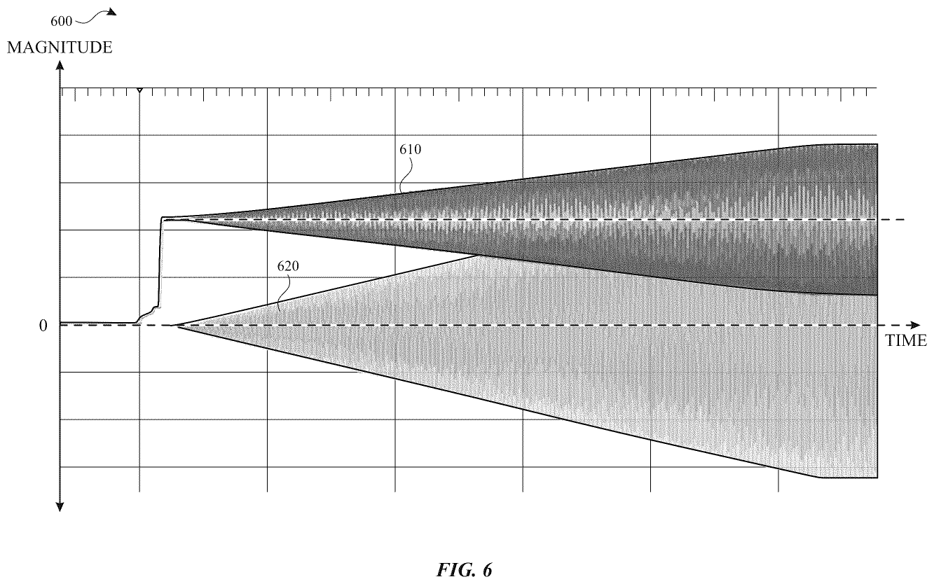

FIG. 6 illustrates a plot diagram 600 of example differential waveforms for performing dynamic opacity variation in a roof glass system in accordance with one or more implementations of the subject technology. In one or more implementations, a differential between two PWM signals represented as sine waves may be created to produce a fading effect on the PDLC glass of the roof glass system 130. This fading effect may be controlled by the controller 120, allowing for dynamic adjustability of the differential voltage output (e.g., PDLC H, PDLC L). For example, the differential voltage output can range from zero volts, resulting in complete opacity, to the full 48-volt RMS output, resulting in complete transparency, or any level of opacity in between. The fading transition between the opaque state and the transparent state can occur over a duration of time (e.g., a few seconds) with the fading duration being controllable in real-time via the controller 120.

The plot diagram 600 depicts a waveform 610 generated by the power control system 500 of FIG. 5 that can include two channels. In one or more implementations, these two channels may initially start as small amplitude sine waves and gradually increase in magnitude over time. Electrically, the inverter 530 output resembles a bridge-tied load, consisting of two inverter outputs (e.g., PDLC H, PDLC L). One gate driver output in the inverter 530 can generate a complementary symmetrical inverter (CSI) waveform, starting from zero and increasing, while the other gate driver output in the inverter 530 can generate the opposite waveform, starting from maximum and decreasing. These waveforms oppose each other. Both waveforms are offset to half of the bus voltage, eliminating the need for a negative supply.

In one or more implementations, the fading effect in the roof glass system 130 may involve utilizing a differential between the two waveforms corresponding to the two channels. For example, the differential voltage can be determined by subtracting one waveform from the other. The plot diagram 600 also depicts a differential waveform 620 that represents the voltage difference observed across the two channels during this process. In one or more implementations, the differential waveform 620 indicates the extent of alignment and polarization of the polymer molecules in the PDLC glass, influencing its optical properties. This process allows for dynamic control over the opacity variation across the PDLC glass of the roof glass system 130, enabling smooth transitions between transparent and opaque states.

In one or more implementations, a linear ramp or linear fade, along with various waveform types (e.g., sine, square, among others) can be employed, with the option to adjust their duration. In one or more other implementations, the waveform 610 may originate directly from a PWM source and undergo processing through logic circuits in the inverter 530 of FIG. 5 to generate the desired differential effect as depicted by the differential waveform 620.

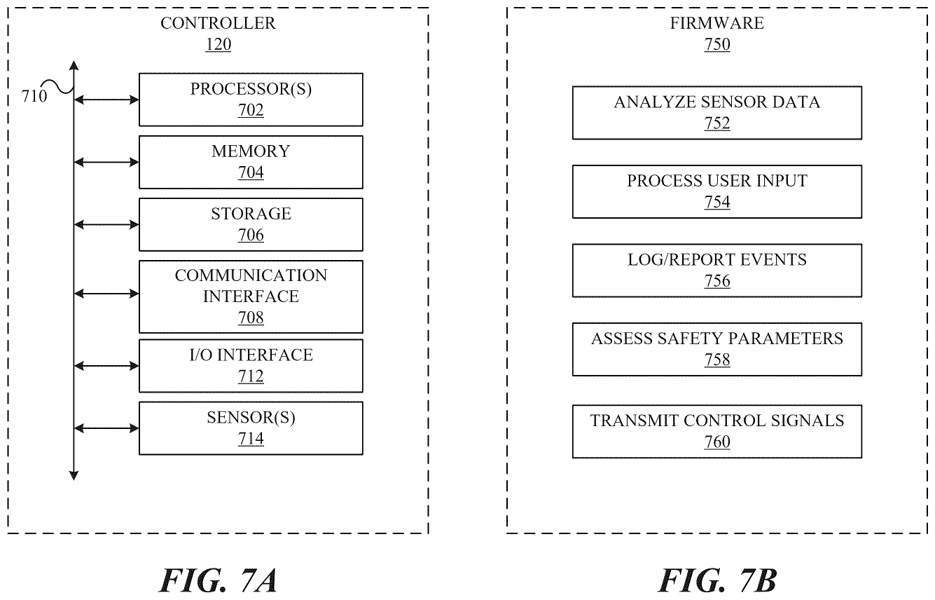

FIG. 7A illustrates a block diagram of an example controller 120 in accordance with one or more implementations of the subject technology. Controller 120 may include a processor(s) 702, memory 704, storage 706, a communication interface 708, a bus 710, an input/output (I/O) interface 712, and sensor(s) 714. Although this disclosure describes one example computer system including specified components in a particular arrangement, this disclosure contemplates any suitable computer system with any suitable number of any suitable components in any suitable arrangement. As an example and not by way of limitation, controller 120 may be an electronic control unit (ECU), an embedded computer system, a system-on-chip, a single-board computer system, a desktop computer system, a laptop or notebook computer system, a mainframe, a mesh of computer systems, a mobile telephone, a personal digital assistant, a server computing system, a tablet computer system, or a combination of two or more of these. Where appropriate, controller 120 may be unitary or distributed, span multiple locations, machines, or data centers; or reside in a cloud, which may include one or more cloud components in one or more networks. Where appropriate, controller 120 may perform, at different times or at different locations, in real time or in batch mode, one or more steps of one or more methods described or illustrated herein.

Processor(s) 702 may include hardware for executing instructions, such as those making up a computer program. As an example and not by way of limitation, to execute instructions, processor(s) 702 may retrieve (or fetch) the instructions from an internal register, an internal cache, memory 704, or storage 706; decode and execute them; and then write one or more results to an internal register, an internal cache, memory 704, or storage 706. Processor(s) 702 may include one or more internal caches for data, instructions, or addresses.

In one or more implementations, memory 704 includes main memory for storing instructions for processor(s) 702 to execute or data for processor(s) 702 to operate on. In one or more other implementations, one or more memory management units (MMUs) reside between processor(s) 702 and memory 704 and facilitate accesses to memory 704 requested by processor(s) 702. In one or more other implementations, memory 704 includes random access memory (RAM). This disclosure contemplates any suitable RAM.

In one or more implementations, the storage 706 includes mass storage for data or instructions. As an example and not by way of limitation, storage 706 may include a removable disk drive, flash memory, an optical disc, a magneto-optical disc, magnetic tape, or a Universal Serial Bus (USB) drive or two or more of these. Storage 706 may include removable or fixed media and may be internal or external to controller 120. Storage 706 may include any suitable form of non-volatile, solid-state memory or read-only memory (ROM). The storage 706 may store static data and instructions that are needed by the one or more processor(s) 702 and other modules of the controller 120. The storage 706, on the other hand, may be a read-and-write memory device. The storage 706 may be a non-volatile memory unit that stores instructions and data even when the computer system 800 is off. In one or more implementations, a mass-storage device (such as a magnetic or optical disk and its corresponding disk drive) may be used as the storage 706.

In one or more implementations, communication interface 708 includes hardware, software, or both providing one or more interfaces for data communication between controller 120 and one or more other computer systems or one or more networks. Communication interface 708 may include one or more interfaces to a controller area network (CAN) or to a local interconnect network (LIN). Communication interface 708 may include one or more of a serial peripheral interface (SPI) or an isolated serial peripheral interface (isoSPI). In some embodiments, communication interface 708 may include a network interface controller (NIC) or network adapter for communicating with an Ethernet or other wire-based network or a wireless NIC (WNIC) or wireless adapter for communicating with a wireless network, such as a WI-FI network or a cellular network.

In one or more implementations, bus 710 includes hardware, software, or both coupling components of controller 120 to each other. Bus 710 may include any suitable bus, as well as one or more buses 710, where appropriate. Although this disclosure describes a particular bus, any suitable bus or interconnect is contemplated. The bus 710 collectively represents all system, peripheral, and chipset buses that communicatively connect the numerous internal devices and/or components of the controller 120. In one or more implementations, the bus 710 communicatively connects the one or more processor(s) 702 with the memory 704 and the storage 706. From these various memory units, the one or more processor(s) 702 retrieves instructions to execute and data to process in order to execute the processes of the subject disclosure. The one or more processor(s) 702 can be a single processor or a multi-core processor in different implementations.

In one or more implementations, I/O interface 712 includes hardware, software, or both, providing one or more interfaces for communication between controller 120 and one or more input and/or output (I/O) devices. Controller 120 may be communicably connected to one or more of these I/O devices, which may be incorporated into, plugged into, paired with, or otherwise communicably connected to the vehicle 100. An input device may include any suitable device for converting volitional user input into digital signals that can be processed by controller 120, such as, by way of example and not limitation, a steering wheel, a touch screen, a microphone, a joystick, a scroll wheel, a button, a toggle, a switch, a dial, or a pedal. An input device may include one or more sensors for capturing different types of information, such as, by way of example and not limitation. An output device may include devices designed to receive digital signals from controller 120 and convert them to an output format, such as, by way of example and not limitation, speakers, headphones, a display screen, a heads-up display, a lamp, a smart vehicle accessory, another suitable output device, or a combination thereof. The output device may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. The present disclosure contemplates any suitable I/O devices and any suitable I/O interfaces 712 for them. I/O interface 712 may include one or more I/O interfaces 712, where appropriate.

In one or more implementations, the I/O interface 712 enables users to interact with and manage various aspects of the roof glass system 130 of FIG. 1 by receiving user input or commands that affect the circuitry of the power control system 500 of FIG. 5 and the controller 120 of FIG. 1. The I/O interface 712 may serve as a bridge between the user's commands and functionality of the roof glass system 130. Users can configure user preferences via the I/O interface 712 to adjust parameters related to the fading effect and opacity levels of the PDLC glass of the roof glass system 130. In one or more implementations, user preferences can influence parameters such as maximum opacity. In one or more implementations, the type of fading effect employed by the PDLC glass can be adjusted based on the user preferences. This adjustment may include selecting the waveform for fading, such as exponential fading or linear fading, or specifying the number of steps involved in the fading process.

In one or more implementations, the I/O interface 712 may provide users with feedback. For example, the I/O interface 712 may provide for display, via an output device, a visual indication, representing the intermediate states between zero and 48 volts (or between opaque and transparent states). This feedback via the I/O interface 712 may be implemented through various means, such as pop-up notifications, submenus, or dedicated UI elements. In one or more other implementations, the I/O interface 712 may receive user commands indicating adjustments to the opacity levels of the roof glass system 130 through different control interfaces via certain input devices including touchscreens, steering wheel controls, or other infotainment menus.

In one or more other implementations, the I/O interface 712 may provide predefined presets for setting different opacity levels in the roof glass system 130. In one or more implementations, these presets may be predetermined and non-user configurable. In one or more other implementations, these presets may be user configurable. In one or more implementations, user-configurable options may include settings for the fade transition duration, specifying the time taken for the transition from opaque state to transparent state, and setting a separate duration for the transition from transparent state to opaque state. While fault handling and safety measures may be assigned the highest priority, under normal operation, user preferences can be accommodated in some implementations.

In one or more implementations, sensor(s) 714 may include a temperature sensor, which may be located in one or more locations in and around the vehicle 100 (e.g., to measure the temperature inside the cabin of the vehicle 100). In one or more other implementations, sensor(s) 714 may include a location sensor, which may be used in determining device position based on positioning technology. For example, the location sensor may provide for one or more of GNSS positioning, wireless access point positioning, cellular phone signal positioning, Bluetooth signal positioning, image recognition positioning, and/or an inertial navigation system (e.g., via motion sensors such as an accelerometer and/or gyroscope). In one or more implementations, the sensor(s) 714 may be utilized to detect movement, travel, and orientation of the controller 120. For example, the sensor(s) may include an accelerometer, a rate gyroscope, and/or other motion-based sensor(s). The sensor(s) 714 may include one or more biometric sensors and/or image sensors for authenticating a user.

In one or more implementations, the sensor(s) 714 includes an ambient light sensor (ALS). The roof glass system 130 may allow for automatic adjustment of the opacity level in the PDLC glass based on input from the ALS. When high sunlight levels are detected by the ALS, causing potential glare through the roof glass system 130, the controller 120 may automatically transition the PDLC glass to a more opaque state to enhance cabin comfort. At night, the PDLC glass can be adjusted to a transparent state, allowing visibility of the night sky. This sensor functionality integrates with the high-level control via the controller 120, enabling dynamic response to environmental lighting conditions to optimize the user experience with the roof glass system 130. In one or more other implementations, the high-level behavior of the roof glass system 130 can incorporate various types of inputs beyond the ALS. For example, global positioning system (GPS) data and time data can be utilized to determine location information of the vehicle 100 (e.g., latitude and longitude coordinates) to predict when the sun may be overhead, irrespective of ALS readings.

In one or more other implementations, the sensor(s) 714 includes a temperature sensor. The temperature sensor may be located within the cabin of the vehicle 100, as the interior temperature of the vehicle 100 may closely mirror the environmental conditions experienced by the exterior glass portion of the roof glass system 130. In one or more other implementations, the temperature sensor may be installed directly on the PDLC glass, specifically within the polymer matrix layer 306. In one or more implementations, the polymer matrix layer 306 may be in closer proximity to the cabin of the vehicle 100 than to the external environment. In one or more other implementations, a combination of internal and external temperatures may be utilized for controlling the opacity levels of the roof glass system 130. In one or more implementations, the optical properties and transition times of the PDLC glass can be significantly influenced by temperature variations. In this regard, the controller 120 can compensate for changes in optical properties due to temperature fluctuations. As such, the temperature readings can be utilized to adapt the transition times of the PDLC glass, facilitating optimal performance under different temperature conditions.

In one or more implementations, transition times for adjusting the opacity levels in the PDLC glass can be managed solely through the controller 120. For example, the controller 120 may issue an instruction that changes the rate at which the electrical drive signal (e.g., the output current produced by the power control system 500) is ramped up, either slower or quicker, to modify the transition time. In one or more implementations, the transition time may be influenced by two factors: 1) the speed at which the electrical drive signal is applied, and 2) the electrochemical and optical properties of the PDLC glass. By manipulating the electrical components in the power control system 500, which the controller 120 can control, the transition time can be adapted to compensate for variations in the optical properties of the PDLC glass due to temperature changes. For example, in colder temperatures, the electrical drive signal can be accelerated to offset any slowing of the PDLC glass's optical response, facilitating consistent performance across different thermal conditions.

By selecting a fade transition duration longer than the natural transition time of the PDLC glass, the controller 120 can dynamically adjust the fading speed based on external temperature readings by one or more temperature sensors. In one or more implementations, this compensation process may utilize measurement data from the temperature sensor measuring the temperature of the external environment and a thermal model correlating the optical properties of the PDLC glass with temperature. For example, the thermal model may be configured to estimate transition times for the PDLC glass. In one or more other implementations, the thermal model can integrate temperature data that reflects the behavior of the PDLC glass over time, which may be stored in the storage 706 and accessible to the controller 120 and/or to the roof glass system 130 via the bus 710.

In one or more implementations, the thermal model can include data that characterizes the optical properties of the PDLC glass in relation to temperature variations. In one or more implementations, the thermal model may consider mechanical factors, such as the specific vehicle model and configuration, including variations in glass size and supplier. In one or more implementations, each specific vehicle model may be associated with a separate (or different) thermal model to accurately represent the behavior of the PDLC glass installed on the specific vehicle model under different conditions. In one or more other implementations, changes in PDLC glass parameters, such as size or supplier, may necessitate adjustments to the thermal model. In one or more other implementations, the controller 120 and/or the roof glass system 130 may access separate thermal models tailored for specific temperature ranges to switch between different thermal models based on operating conditions.

In one or more implementations, the thermal model may utilize a first-order linear system. In one or more other implementations, the thermal model may utilize a second-order linear system. In one or more implementations, the thermal model may employ a leaky bucket integrator to predict the gradual leakage of temperature changes over time. In one or more other implementations, the thermal model may employ a weighted average between external and internal temperatures to compute the temperature dynamics affecting the behavior of the PDLC glass.

In one or more implementations, the thermal model output, which predicts the duration of a transition, may serve as a baseline. If a user preference indicates a different transition time than the thermal model prediction, the controller 120 can calculate a deviation between the baseline and user preference value, and the controller 120 sends an instruction to adjust the transition time according to the calculated deviation. For example, if the thermal model predicts a transition will take three seconds but the user preference indicates a five-second transition, the controller 120 can compensate by extending the transition time by two seconds. In one or more other implementations, adjustments to the transition times may be subject to physical limitations, such as extreme cold temperatures, which may affect the accuracy of transition times. For example, the controller 120 may strive to achieve the desired transition time to the best of its ability, considering the constraints imposed by the PDLC glass optical properties. In one or more other implementations, the cabin of the vehicle 100 may be preconditioned by warming the cabin to a desired temperature that influences the PDLC glass optical properties, potentially enabling more accurate control over transition times.

In one or more implementations, a computer-readable non-transitory storage medium or media may include one or more semiconductor-based or other integrated circuits (ICs) (such, as for example, field-programmable gate arrays or application-specific ICs), hard disk drives, hybrid hard drives, optical discs, optical disc drives, magneto-optical discs, magneto-optical drives, solid-state drives, RAM drives, any other suitable computer-readable non-transitory storage media, or any suitable combination. A computer-readable non-transitory storage medium may be volatile, non-volatile, or a combination of volatile and non-volatile, where appropriate.

FIG. 7B illustrates a block diagram of example firmware 750 for the controller 120 of FIG. 7A in accordance with one or more implementations of the subject technology. Firmware 750 may include functions 752 for analyzing sensor data based on signals received from sensors 714 received through communication interface 708. Firmware 750 may include functions 754 for processing user input (e.g., directly provided by a driver of or passenger in the vehicle 100, or provided through the controller 120) received through I/O interface 712. Firmware 750 may include functions 756 for logging detected events (which may be stored in storage 706 or uploaded to the cloud), as well as functions for reporting detected events (e.g., to a driver or passenger of the vehicle through an instrument display or interactive interface of the vehicle, or to a vehicle manufacturer, service provider, or third party through communication interface 708). Firmware 750 may include functions 758 for assessing safety parameters (e.g., monitoring the temperature of a vehicle battery or the distance between vehicle 100 and nearby vehicles). Firmware 750 may include functions 760 for transmitting control signals to components of vehicle 100, including other controllers 120. For example, functions 760 may include transmitting control signals to the roof glass system 130 to dynamically adjust the opacity of the roof glass system 130.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the present disclosure. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different orders. Some of the steps, operations, or processes may be performed simultaneously. The accompanying method claims, if any, present elements of the various steps, operations, or processes in a sample order, and are not meant to be limited to the specific order or hierarchy presented. These may be performed in serial, linearly, in parallel, or in different order. It should be understood that the described instructions, operations, and systems can generally be integrated together in a single software/hardware product or packaged into multiple software/hardware products.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A system, comprising:
a glass system; and
a controller configured to:
cause modulation of an input voltage supply to generate a pair of differential bias voltage signals; and
cause one or more adjustments to an opacity of the glass system using the pair of differential bias voltage signals, wherein the one or more adjustments correspond to different levels of opacity between an opaque state and a transparent state of the glass system.

2. The system of claim 1, wherein the controller is further configured to cause one or more adjustments to a duty cycle of at least one input pulse width modulation signal to modulate the input voltage supply.

3. The system of claim 1, wherein the controller is further configured to cause a conversion of the input voltage supply from a first voltage to a second voltage greater than the first voltage, wherein the input voltage supply at the second voltage is modulated with a pair of input pulse width modulation signals.

4. The system of claim 1, wherein the controller configured to cause one or more adjustments to the opacity of the glass system is further configured to cause driving a transition from the opaque state to the transparent state of the glass system based on the pair of differential bias voltage signals having a nonzero differential output voltage.

5. The system of claim 1, wherein the controller configured to cause one or more adjustments to the opacity of the glass system is further configured to cause driving a transition from the transparent state to the opaque state of the glass system based on the pair of differential bias voltage signals having a zero differential output voltage.

6. The system of claim 1, wherein the glass system comprises polymer-dispersed liquid crystal (PDLC) glass.

7. The system of claim 1, wherein the one or more adjustments to the opacity of the glass system corresponds to a fading effect based on a number of voltage steps in each of the pair of differential bias voltage signals.

8. A method, comprising:
generating a plurality of differential bias voltage signals by modulating an input voltage supply with a plurality of input pulse width modulation signals; and
biasing a glass system of a vehicle with the plurality of differential bias voltage signals to adjust an opacity of the glass system, wherein adjustment to the opacity corresponds to one or more different levels of opacity between an opaque state and a transparent state of the glass system.

9. The method of claim 8, wherein biasing the glass system comprises causing one or more adjustments to a duty cycle of at least one of the plurality of input pulse width modulation signals to modulate the input voltage supply.

10. The method of claim 8, further comprising causing a conversion of the input voltage supply from a first voltage to a second voltage greater than the first voltage, wherein the input voltage supply at the second voltage is modulated with a pair of input pulse width modulation signals.

11. The method of claim 8, wherein biasing the glass system comprises driving a transition from the opaque state to the transparent state of the glass system based on the plurality of differential bias voltage signals having a nonzero differential output voltage.

12. The method of claim 8, wherein biasing the glass system comprises driving a transition from the transparent state to the opaque state of the glass system based on the plurality of differential bias voltage signals having a zero differential output voltage.

13. The method of claim 8, wherein adjustment to the opacity of the glass system corresponds to a fading effect based on a number of voltage steps in each of the plurality of differential bias voltage signals.

14. The method of claim 8, wherein the glass system comprises polymer-dispersed liquid crystal (PDLC) glass.

15. A vehicle, comprising:
a battery;
a glass system;
a power converter configured to:
receive an input voltage supply from the battery; and
convert the input voltage supply from a first voltage to a second voltage greater than the first voltage;
an inverter coupled to the power converter and configured to generate a pair of differential bias voltage signals by modulating the input voltage supply at the second voltage with a plurality of input pulse width modulation signals; and
a controller configured to cause one or more adjustments to an opacity of the glass system with the pair of differential bias voltage signals, wherein the one or more adjustments correspond to different levels of opacity between an opaque state and a transparent state of the glass system.

16. The vehicle of claim 15, wherein the controller is further configured to cause one or more adjustments to a duty cycle of at least one of the plurality of input pulse width modulation signals to modulate the input voltage supply.

17. The vehicle of claim 15, wherein the controller configured to cause one or more adjustments to the opacity of the glass system is further configured to cause driving a transition from the opaque state to the transparent state of the glass system based on the pair of differential bias voltage signals having a nonzero differential output voltage.

18. The vehicle of claim 15, wherein the controller configured to cause one or more adjustments to the opacity of the glass system is further configured to cause driving a transition from the transparent state to the opaque state of the glass system based on the pair of differential bias voltage signals having a zero differential output voltage.

19. The vehicle of claim 15, wherein the one or more adjustments to the opacity of the glass system corresponds to a fading effect based on a number of voltage steps in each of the pair of differential bias voltage signals.

20. The vehicle of claim 15, wherein the glass system comprises polymer-dispersed liquid crystal (PDLC) glass.
